(19) United States
(12) Patent Application Publication
(10) Pub. No.: US 2022/0250159 A1
(43) Pub. Date: Aug. 11, 2022

(54) APPARATUS FOR MULTI-SCALE DIRECTED ENERGY DEPOSITION WITH INTEGRAL NON-ABRASIVE REDUCTION OF WAVINESS

(71) Applicant: Divergent Technologies, Inc., Los Angeles, CA (US)

(72) Inventor: Michael Thomas KENWORTHY, Rancho Palos Verdes, CA (US)

(21) Appl. No.: 17/665,980

(22) Filed: Feb. 7, 2022

Related U.S. Application Data
(60) Provisional application No. 63/146,986, filed on Feb. 8, 2021.

(51) Int. Cl. B22F 12/55; B22F 10/25; C25D 1/00; B33Y 10/00; B33Y 30/00; B33Y 40/20

(52) U.S. Cl. CPC B22F 12/55; B22F 10/25; B33Y 40/20; B33Y 10/00; B33Y 30/00; C25D 1/003

(57) ABSTRACT

Aspects are provided for additively manufacturing a component with reduced surface roughness based on direct energy deposition (DED). A DED apparatus for additively manufacturing a component includes a material supply, one or more deposition heads coupled to the material supply to deposit feedstock from the material supply, and an energy source configured to heat the feedstock as the feedstock is being deposited by the one or more deposition heads. The energy source is configured to reheat one or more portions of a surface of the component to reduce surface roughness as the component is being additively manufactured. The one or more deposition heads may also comprise a plurality of deposition heads which are sized to deposit the feedstock from the material supply at different resolutions to form a surface of the component with reduced surface roughness as the component is being additively manufactured. Thus, structural integrity may be improved.

### CROSS REFERENCE TO RELATED APPLICATION(S)

This application claims the benefit of U.S. Provisional Application Ser. No. 63/146,986, entitled “APPARATUS FOR MULTI-SCALE DIRECTED ENERGY DEPOSITION WITH INTEGRAL NON-ABRASIVE REDUCTION OF WAVINESS” and filed on Feb. 8, 2021, the disclosure of which is expressly incorporated by reference herein in its entirety.

### BACKGROUND

### Field

The present disclosure relates generally to directed energy deposition (DED) systems, and more particularly, to in-situ reduction of surface roughness in components manufactured using DED systems.

### Background

Additive manufacturing (AM) has provided a significant evolutionary step in the development and manufacture of vehicles and other transport structures. For nearly a century prior to the introduction of AM, manufacturers have been relegated to the assembly line technique of vehicle production using conventional machining to construct and assemble vehicle parts. Because the machined parts are generally specific to a vehicle model design, and as acquiring new tooling to construct modified parts can be cost prohibitive, manufacturers have had limited flexibility to implement modifications to an established vehicle design. As a result, a manufacturing facility often uses assembly lines that are limited to producing a single vehicle model.

One example of an AM system is DED. DED systems can produce structures, referred to as build pieces, with geometrically complex shapes, including some shapes that are difficult or impossible to create with conventional manufacturing processes. DED systems create build pieces layer by layer. Each layer is formed by depositing a layer of material such as wire or powder and melting the material upon deposition with a heat source such as energy beam, laser beam, or plasma arc. The melted wire or powder cools and fuses to form a layer of the build piece. Each layer is deposited on top of the previous layer. The resulting structure is a build piece manufactured layer-by-layer from the ground up.

However, rough surfaces or “waviness” may result from assembly of a build piece using DED systems. For example, as deposited material is melted and added layer-by-layer, grooves may be formed on the exterior and interior surfaces of each layer. Such grooves may serve as stress concentrations of the build piece, possibly leading to fatigue cracks and failure of the build piece over time.

### SUMMARY

Several aspects of apparatuses and methods for reducing surface roughness of an additively manufactured component or structure will be described more fully hereinafter.

In various aspects, a DED apparatus for additively manufacturing a component may include a material supply, one or more deposition heads coupled to the material supply to deposit feedstock from the material supply, and an energy source configured to heat the feedstock as the feedstock is being deposited by the one or more deposition heads. The energy source is configured to reheat one or more portions of a surface of the component to reduce surface roughness as the component is being additively manufactured.

In various aspects, a DED apparatus for additively manufacturing a component may include a material supply, a plurality of deposition heads coupled to the material supply to deposit feedstock from the material supply, and an energy source configured to heat the feedstock as the feedstock is being deposited by at least one of the plurality of deposition heads. The plurality of deposition heads are sized to deposit the feedstock from the material supply at different resolutions to form a surface of the component with reduced surface roughness as the component is being additively manufactured.

In various aspects, a method of additively manufacturing a component with reduced surface roughness based on DED includes depositing feedstock from a material supply using a plurality of deposition heads, heating the feedstock using an energy source as the feedstock is deposited to form the component, and reheating one or more portions of a surface of the component. The plurality of deposition heads are sized to deposit the feedstock from the material supply at different resolutions

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1 is a conceptual diagram illustrating an example wire DED system.

FIG. 2 is a conceptual diagram illustrating an example powder DED system.

FIGS. 3A and 3B are conceptual diagrams illustrating examples of surface roughness resulting from assembly of a component using powder and wire DED systems, respectively.

FIG. 4 is a conceptual diagram illustrating an example DED system for reducing surface roughness of an additively manufactured component.

FIG. 5 is a conceptual diagram illustrating an example of surface smoothing using a combination of coarse and fine powders in DED.

FIG. 6 illustrates a method of additively manufacturing a component with reduced surface roughness based on DED.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

Being non-design specific, AM is capable of enabling construction of an almost unlimited variety of structures having diverse geometrical shapes and material characteristics. Different AM printers (e.g., using DED) can provide these structures using a variety of materials, including metals, alloys and thermoplastics. In a new infrastructure hereinbefore proposed by Applicant, AM becomes a primary means of developing custom parts. Parts made via traditional machining and casting, together with widely available commercial off-the-shelf (COTS) parts, can be linked together in a modular form via these custom AM structures to form a chassis of a vehicle, fuselage of an aircraft, body of a sea vessel, and the like. AM modular parts can also be printed that form the interior of the transport structure. Design modifications are straightforward and can be effected by printing modified AM structures, which avoids the expense of acquiring new tooling.

In a DED system, a build piece may be additively manufactured by using an energy source to provide heat while a layer of material is being deposited. The deposited material is allowed to cool, and the process is repeated layer-by-layer until the build piece is fully manufactured. However, such additive manufacturing may cause rough surfaces to be formed on the build piece, resulting in stress concentrations and low fatigue resistance. While these stress concentrations can be addressed by abrading or cutting the surfaces to remove the roughness, such approach may result in material waste and longer times for assembling the component. For example, the build piece may be required to cool before abrasive operations can be performed and the cut material discarded, inefficiently increasing the overall process time. Such abrasive operations may also impact the aesthetics of the build piece.

Aspects of the present disclosure improve the aesthetics as well as the dynamic performance (or fatigue resistance) of such build pieces or components by non-abrasively removing waviness or surface roughness in-situ with the additive manufacturing process. For example, an energy source may selectively re-melt small portions of a surface of the build piece to allow surface tension to reduce waviness and primary surface roughness of an additively manufactured component. Moreover, a multi-scale DED apparatus may incorporate multiple size deposition heads and feedstock types (e.g., both powder and wire) to mitigate waviness in critical areas of the additively manufactured component. For example, if exterior surface roughness is considered to be more critical than interior surface roughness, a smaller deposition head with a finer resolution may be used to re-melt the exterior surface while a larger deposition head with a coarser resolution may be used to re-melt the interior surface. Thus, material or features may be deposited at a finer resolution in critical areas to produce smooth, high grade material using additional processing time, while non-critical areas may be manufactured using high rate processes for bulk material growth (e.g., using larger deposition heads). Such integration of in situ surface processing into a multi-scale DED apparatus, rather than implementing an abrasive or cutting process, may reduce material waste and optimize overall process time. For example, previously pre-heated material from one or more prior additive deposition steps or layers may be re-melted to reduce waviness as opposed to potentially waiting for cooling of the build piece to form subtractive operations.

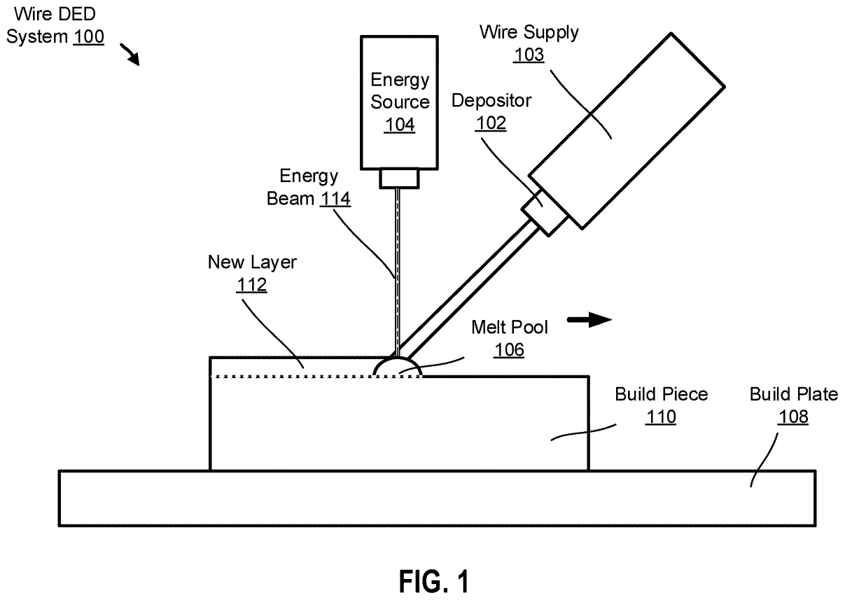

FIG. 1 illustrates an example wire DED system 100 for additive manufacturing using wire. Wire DED system 100 can include a depositor 102 that can deposit each layer of wire from a wire supply 103, an energy source 104 that can generate heat to melt each layer of material upon deposition and form a melt pool 106, and a build plate 108 that can support one or more build pieces, such as build piece 110. The example of FIG. 1 shows wire DED system 100 after multiple layers of build piece 110 have each been deposited, and while a new layer 112 is being deposited. While depositing the new layer, build piece 110 can remain stationary, and depositor 102 and energy source 104 can cross a length and width of the build piece while releasing wire and generating heat, respectively. Alternatively, depositor 102 and energy source 104 can remain stationary, and build piece 110 can move under the depositor and energy source instead. The energy source may generate an energy beam 114, a laser beam, or other source of heat to melt the deposited material for each layer.

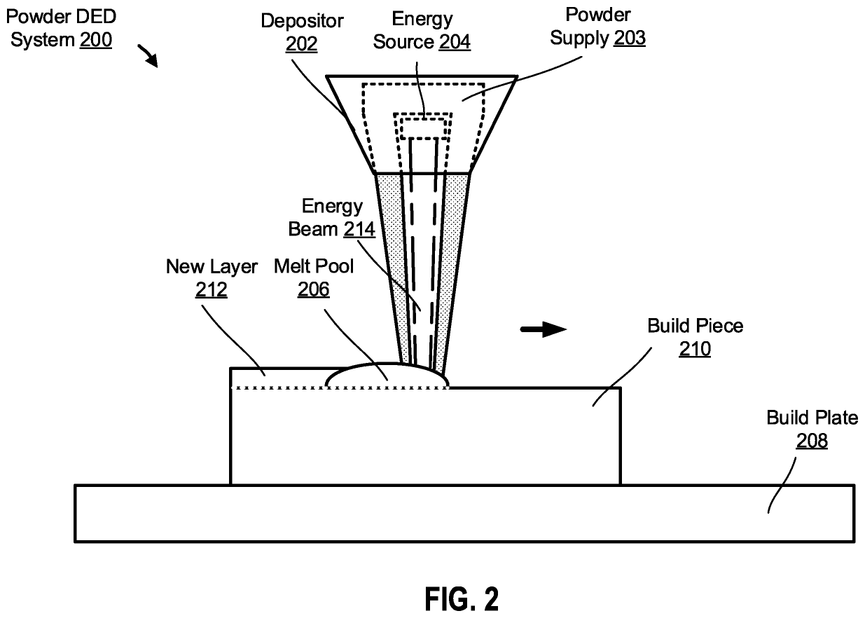

FIG. 2 illustrates an example powder DED system 200 for additive manufacturing using powder. Powder DED system 200 can include a depositor 202 that can deposit each layer of powder from a powder supply 203, an energy source 204 that can generate heat to melt each layer of material upon deposition and form a melt pool 206, and a build plate 208 that can support one or more build pieces, such as build piece 210. The example of FIG. 2 shows powder DED system 200 after multiple layers of build piece 210 have each been deposited, and while a new layer 212 is being deposited. While depositing the new layer, build piece 210 can remain stationary, and depositor 202 and energy source 204 can cross a length and width of the build piece while releasing powder and generating heat, respectively. Alternatively, depositor 202 and energy source 204 can remain stationary, and build piece 210 can move under the depositor and energy source instead. The energy source may generate an energy beam 214, a laser beam, or other source of heat to melt the deposited material for each layer.

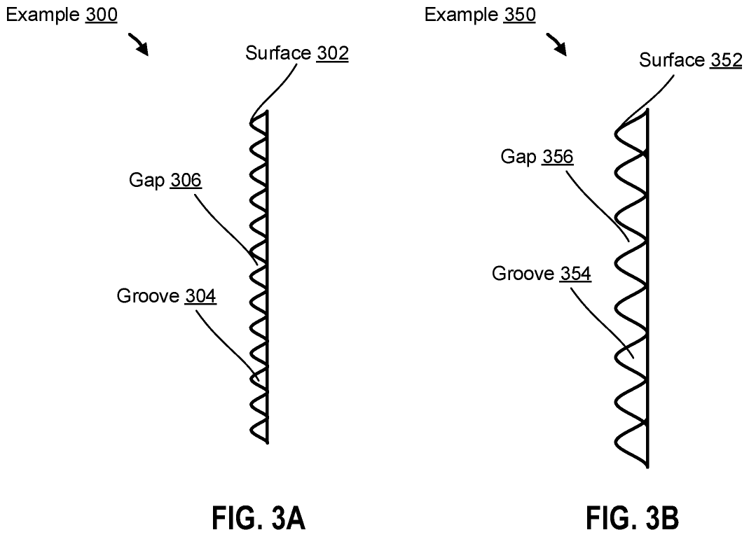

FIGS. 3A and 3B illustrate examples 300, 350 of a surface 302, 352 of an additively manufactured component. The additively manufactured component of FIG. 3A may correspond to build piece 210 of powder DED system 200 after multiple layers of powder have been deposited, while the additively manufactured component of FIG. 3B may correspond to build piece 110 of wire DED system 100 after multiple layers of wire have been deposited. As new layers 112, 212 of material are deposited to form the component, grooves 304, 354 may be formed on a surface of the formed component which are separated by gaps 306, 356. For example, as depositor 102 and energy source 104, 204 (or build piece 110, 210) move and melt pool 106, 206 cools at the end of each layer, grooves or valleys may result along a surface formed by all of the layers. The size of gaps 306, 356 may change depending on the additive manufacturing system used to manufacture the component. For example, gaps 306 formed by powder DED system 200 may be approximately 30 microns in length, gaps 356 formed by wire DED system 100 may be larger, and gaps formed by other systems (e.g., powder bed fusion, cold spray) may be smaller. The roughness of surface 302, 352 caused by grooves 304, 354 may result in stress concentrations that possibly lead to fatigue cracks, affecting the structural integrity of the additively manufactured component.

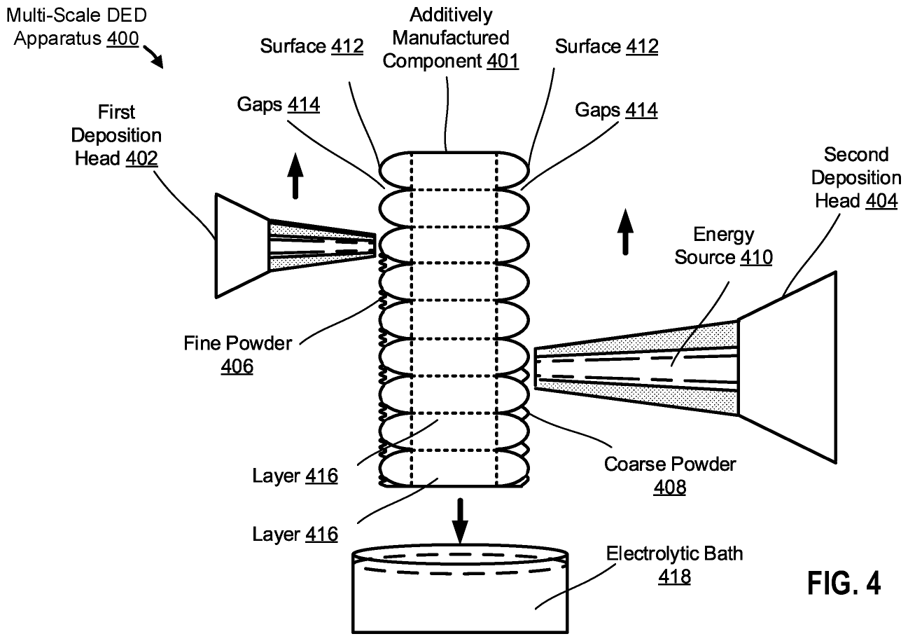

FIG. 4 illustrates an example of a multi-scale DED apparatus 400 that improves the structural integrity of an additively manufactured component 401 by reducing surface roughness. Multi-scale DED apparatus 400 includes multiple depositors or deposition heads of varying resolutions, including a first deposition head 402 and a second deposition head 404. In the example of FIG. 4, both the first deposition head and second deposition head deposit powder as feedstock material, similar to depositor 202 in powder DED system 200, but with different resolutions. For example, first deposition head 402 may be smaller than, and deposit fine powder 406 with a finer resolution than, second deposition head 404. Similarly, second deposition head 404 may be larger than, and deposit coarse powder 408 with a coarser resolution than, first deposition head 402. An energy source 410 may also be included in each deposition head, similar to energy source 204 in powder DED system 200, for heating deposited powder. In another example, first deposition head 402 and second deposition head 404 may deposit wire as feedstock material, similar to depositor 102 in wire DED system 100, similarly with different resolutions. Energy source 410 may also be included next to each deposition head, similar to energy source 104 in wire DED system 100, for heating deposited wire. In a further example, first deposition head 402 may deposit powder while second deposition head 404 may deposit wire, or vice-versa. In other examples, multi-scale DED apparatus 400 may include any number of deposition heads of different sizes or resolutions that deposit powder, wire, or a combination of either feedstock, with associated energy sources to fuse the deposited material.

Additively manufactured component 401 may include one or more surfaces 412, and the multi-scale DED apparatus may selectively reheat portions of each surface and deposit material to fill in gaps 414 to reduce surface roughness. For example, additively manufactured component 401 may correspond to build piece 110 of FIG. 1 or build piece 210 of FIG. 2 after multiple layers 416 of feedstock have been deposited and fused, and first and second deposition heads 402, 404 may cross a height of the component to deposit and heat material in gaps 414 of grooves formed by the multiple layers. Alternatively, the first and second deposition heads may remain stationary while the component moves, with respect to the stationary deposition heads, to deposit and heat material in the gaps.

The multi-scale DED apparatus may deposit material into gaps 414 at different resolutions. For example, first deposition head 402 may deposit material at a finer resolution (e.g., fine powder 406) to fill gaps 414 of one of the surfaces of additively manufactured component 401, while second deposition head 404 may deposit material at a coarser resolution (e.g., coarse powder 408) to fill gaps 414 of another one of the surfaces of additively manufactured component 401. The multi-scale DED apparatus may move the deposition heads and energy sources, or move the component, to deposit and heat material of finer resolution and coarser resolution at different areas of the component (e.g., different surfaces of the component or different portions of a same surface of the component). For example, finer resolution material may be deposited and heated at a critical area of the component, while coarser resolution material may be deposited and heated at a non-critical area of the component. For instance, at least a portion of one of the surfaces of the component (e.g., an exterior surface of the component) may be considered a critical area, while at least a portion of another of the surfaces of the component (e.g., an interior surface of the component) may be considered a non-critical area. In such case, first deposition head 402 may deposit finer resolution material on the exterior surface or other critical areas, while second deposition head 404 may deposit coarser resolution material on the interior surface or other non-critical areas. The depositing and heating of different resolutions of material provides a balance between improved structural integrity and overall processing time, since depositing and heating finer resolution material may result in less surface roughness (and thus more structural integrity) but may take longer to process than depositing and heating coarser resolution material. Therefore, by expending more processing time on critical areas and allowing bulk material deposits in non-critical areas, efficient surface smoothing may be achieved.

Other example processes that may further improve structural integrity of additively manufactured components by reducing surface roughness or otherwise providing fatigue resistance may be considered. In one example, laser shock peening may be applied to zones of a part requiring maximal fatigue resistance, since local plastic deformation of a thin surface layer may impart beneficial compressive residual stresses that may inhibit initiation and propagation of cracks. For example, referring to FIG. 4, laser shock peening may further be applied to at least a portion of one of the surfaces of additively manufactured component 401 which may be considered a critical area or which may otherwise benefit from smoother surfaces or less stress concentrations. For instance, during laser shock peening, energy source 410 in first deposition head 402 or second deposition head 404 (or a different energy source in another deposition head) may emit a high energy laser beam on at least a portion of surface 412. The high energy laser beam may cause a shock wave applying pressure to the surface, in response to which compressive residual stresses may form.

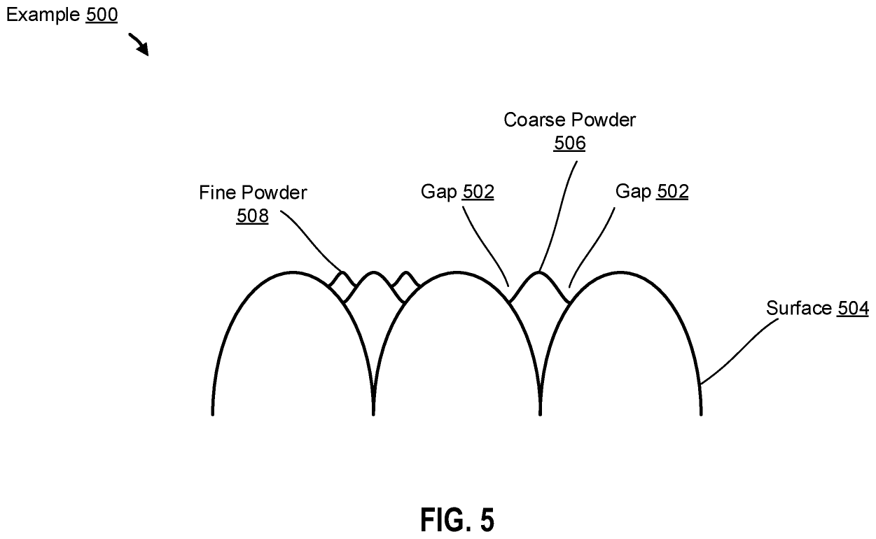

In another example, surface smoothing may be accomplished via additive processes such as cold spray or laser deposition of very fine powders with a specialized nozzle geometry that produces a controlled dispersion pattern designed to fill areas between subsequent layers. For example, referring to FIG. 4, after second deposition head 404 fills in gaps 414 of one of the surfaces of additively manufactured component with coarse powder 408 between multiple layers 416, smaller gaps may be formed on the surface and first deposition head 402 may fill in these smaller gaps with finer powder 406 to enable further surface smoothing. An example 500 of this further surface smoothing is illustrated in FIG. 5, in which gaps 502 are formed on surface 504 after application of coarse powder 506 and therefore fine powder 508 may be subsequently applied to improve structural integrity of the surface.

In a further example, a binder including bound powder may be applied (or some other binder-based process) to the desired surfaces of the additively manufactured component and subsequently sintered. For example, referring to FIG. 4, a binder may be applied to one or more surfaces 412 of additively manufactured component 401 and the bound surface(s) may be subsequently sintered to possibly improve structural integrity in some cases. For instance, first deposition head 402 or second deposition head 404 (or a different deposition head) may deposit a binder, such as a glue or other adhesive, onto the coarse or fine powder deposited on one or more surfaces 412. Subsequently, energy source 410 (or a different energy source) may emit an energy beam or otherwise apply heat to sinter the bound powder.

In another example, an ultrasonic wire-based repair process may be applied to desired areas, such as Ultrasonic Filament Modeling (UFM). For example, referring to FIG. 4, UFM may be applied to one or more surfaces 412 of additively manufactured component 401. For instance, first deposition head 402 or second deposition head 404 (or a different deposition head) may deposit wire on one or more surfaces 412 to fill in gaps 414, and energy source 410 (or a different energy source) may apply ultrasonic energy to the deposited wire to fuse the wire in the gaps.

In an additional example, an ex-situ option such as electroforming or electroplating an additively manufactured component may be applied to reduce the intensity of potential crack initiation sites between subsequent layers. For example, referring to FIG. 4, after additively manufactured component 401 is formed and surface smoothed (or otherwise made more fatigue resistant) as described in any of the aforementioned examples, the surfaces of the additively manufactured component may be electroformed or electroplated to further lessen stress concentrations between multiple layers 416. For instance, multi-scale DED apparatus 400 may include an electrolytic bath 418 in which a metal (the anode) and the additively manufactured component (the cathode) may be immersed. After immersion, a direct current of electricity may be passed through the solution to cause metal ions from the anode to be transferred to the surface of the additively manufactured component. The additional metal thus formed on the surfaces of the additively manufactured component may further lessen stress concentrations between the multiple layers of the component.

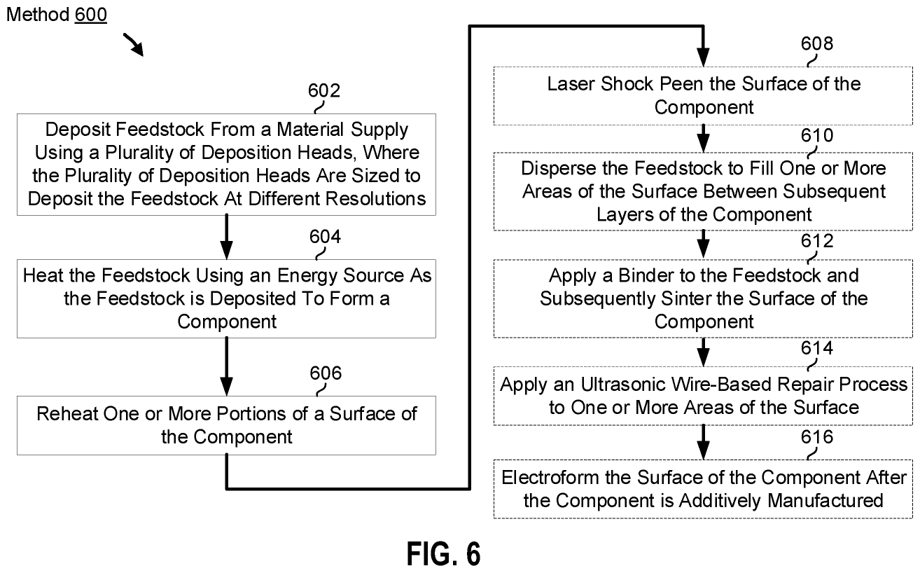

FIG. 6 is a flow diagram illustrating a method 600 of additively manufacturing a component with reduced surface roughness based on direct energy deposition (DED). The component (e.g. additively manufactured component 401) may be an AM structure such as a node, a panel, extrusion or other AM, non-AM, or COTS part, a sub-assembly of parts, or plurality of sub-assemblies. The component may be manufactured using a multi-scale DED apparatus 400. Optional aspects are illustrated in dashed lines. The method reduces surface roughness of the component, thereby providing improved structural integrity.

At 602, feedstock is deposited from a material supply using a plurality of deposition heads. The plurality of deposition heads are sized to deposit the feedstock from the material supply at different resolutions. For example, referring to FIG. 4, multi-scale DED apparatus 400 for creating additively manufactured component 401 may be provided including a material supply (e.g., wire supply 103 or powder supply 203), and first deposition head 402 and second deposition head 404 coupled to their respective material supply to deposit feedstock (e.g., powder or wire) from the material supply. The first and second deposition heads may be sized to deposit their respective feedstock at different resolutions. For example, first deposition head 402 may be smaller and deposit fine powder 406 while second deposition head 404 may be larger and deposit coarse powder 408. The first deposition head may deposit the feedstock in a first area of the additively manufactured component, while the second deposition head may deposit the feedstock in a second area of the component. The first area may comprise a critical area of the component while the second area may comprise a non-critical area of the component. For example, referring to FIG. 4, first deposition head 402 may deposit feedstock on one of the surfaces of the component (e.g., an exterior surface, which may in some cases include a critical area or portion of the surface) and second deposition head 404 may deposit feedstock on another one of the surfaces of the component (e.g., an interior surface, which may in some cases include a non-critical area or portion of the surface).

At 604, the feedstock is heated using an energy source as the feedstock is deposited to form the component. For example, referring to FIG. 4, multi-scale DED apparatus 400 may include energy sources 410 (e.g. energy source 104, 204) that heats the respective feedstock as the feedstock is being deposited by first deposition head 402 and second deposition head 404.

At 606, one or more portions of a surface of the component are reheated. For example, referring to FIG. 4, multi-scale DED apparatus 400 may reheat gaps 414 (e.g., gaps 306, 356) between grooves (e.g., grooves 304, 354) of the one or more surfaces of additively manufactured component 401 using energy sources 410 after multiple layers 416 of the component are deposited, heated and fused, and while the component is still being additively manufactured. The reheating may melt the grooves to fill the gaps to reduce surface roughness and lessen stress concentrations. Moreover, first deposition head 402 and second deposition head 404 may deposit feedstock (e.g., fine powder 406 or coarse powder 408) in between the gaps 414 to be re-heated along with the grooves, thereby improving structural integrity with smoother surfaces.

At 608, the surface of the component may be laser shock peened. For example, referring to FIG. 4, laser shock peening may further be applied to at least a portion of one of the surfaces of additively manufactured component 401 which may be considered a critical area or which may otherwise benefit from smoother surfaces or less stress concentrations. As described above, laser shock peening may be applied to zones of a part requiring maximal fatigue resistance, since local plastic deformation of a thin surface layer may impart beneficial compressive residual stresses that may inhibit initiation and propagation of cracks.

At 610, the feedstock may be dispersed to fill one or more areas of the surface between subsequent layers of the component. In such case, the feedstock may comprise a fine powder. For example, referring to FIG. 4, after second deposition head 404 fills in gaps 414 of one of the surfaces of additively manufactured component with coarse powder 408 between multiple layers 416, smaller gaps may be formed on the surface and first deposition head 402 may fill in these smaller gaps with finer powder 406 to enable further surface smoothing. As described above, surface smoothing may be accomplished via additive processes such as cold spray or laser deposition of very fine powders with a specialized nozzle geometry that produces a controlled dispersion pattern designed to fill areas between subsequent layers. For example, referring to FIG. 5, after gaps 502 are formed on surface 504 in response to application of coarse powder 506, fine powder 508 may be subsequently applied to improve structural integrity of the surface.

At 612, a binder may be applied to the feedstock and the surface of the component may be subsequently sintered. In such case, the feedstock may comprise a powder. For example, referring to FIG. 4, a binder may be applied to one or more surfaces 412 of additively manufactured component 401 and the bound surface(s) may be subsequently sintered to possibly improve structural integrity in some cases. The binder may a bound powder, for example.

At 614, an ultrasonic wire-based repair process may be applied to one or more areas of the surface. In such case, the feedstock may comprise a wire. For example, referring to FIG. 4, UFM may be applied to one or more surfaces 412 of additively manufactured component 401.

Finally, at 616, the surface of the component may be electroformed after the component is additively manufactured. For example, referring to FIG. 4, after additively manufactured component 401 is formed and surface smoothed (or otherwise made more fatigue resistant) as described in any of the aforementioned examples, the surfaces of the additively manufactured component may be electroformed to further lessen stress concentrations between multiple layers 416. Such an ex-situ approach may be applied to reduce the intensity of potential crack initiation sites between subsequent layers.

As a result, the present disclosure improves the aesthetics as well as the fatigue resistance of additively manufactured components by non-abrasively removing waviness or surface roughness in-situ with the additive manufacturing process. Selective re-melting of small portions of a surface of the component, as well as the use of multiple size deposition heads and feedstocks, may reduce waviness and primary surface roughness (e.g., critical areas) of an additively manufactured component. Material or features may be deposited at finer resolutions in critical areas and at coarser resolutions at non-critical areas, thereby reducing material waste and efficiently managing overall process time in contrast to abrasive, cutting or other subtractive processes.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A directed energy deposition (DED) apparatus for additively manufacturing a component, the apparatus comprising:
a material supply;
one or more deposition heads coupled to the material supply that deposit feedstock from the material supply; and
an energy source that heats the feedstock being deposited by the one or more deposition heads and reheats a portion of a surface of the component during the additive manufacturing.

2. The DED apparatus of claim 1, wherein the feedstock comprises at least a powder or a wire.

3. The DED apparatus of claim 1, wherein the one or more deposition heads comprise a plurality of deposition heads which are sized to deposit the feedstock from the material supply at different resolutions.

4. The DED apparatus of claim 3,
wherein a first deposition head of the plurality of deposition heads is sized to deposit the feedstock at a finer resolution than a second deposition head of the plurality of deposition heads;
wherein the first deposition head is configured to deposit the feedstock in a first area of the component; and
wherein the second deposition head is configured to deposit the feedstock in a second area of the component.

5. The DED apparatus of claim 4, wherein the first area comprises a critical area of the component, and wherein the second area comprises a non-critical area of the component.

6. The DED apparatus of claim 3,
wherein the feedstock comprises a fine powder, and
wherein at least one of the plurality of deposition heads is configured to disperse the fine powder to fill one or more areas of the surface between subsequent layers of the component.

7. The DED apparatus of claim 1, wherein the energy source further laser shock peens the surface of the component.

8. The DED apparatus of claim 1, further comprising:
an electrolytic bath in which the surface of the component is electroformed after the component is additively manufactured.

9. The DED apparatus of claim 1, wherein the feedstock comprises a powder, the one or more deposition heads apply a binder to the powder on the surface of the component, and the energy source sinters the bound powder.

10. The DED apparatus of claim 1, wherein the feedstock comprises a wire, the one or more deposition heads deposit the wire on one or more areas of the surface, and the energy source applies ultrasonic energy to the deposited wire.

11. A directed energy deposition (DED) apparatus for additively manufacturing a component, comprising:
a material supply;
a plurality of deposition heads coupled to the material supply to deposit feedstock from the material supply; and
an energy source configured to heat the feedstock as the feedstock is being deposited by at least one of the plurality of deposition heads;
wherein the plurality of deposition heads are sized to deposit the feedstock from the material supply at different resolutions.

12. The DED apparatus of claim 11, wherein the feedstock comprises at least a powder or a wire.

13. The DED apparatus of claim 11, wherein the energy source is configured to reheat one or more portions of the surface of the component as the component is being additively manufactured.

14. The DED apparatus of claim 11,
wherein a first deposition head of the plurality of deposition heads is sized to deposit the feedstock at a finer resolution than a second deposition head of the plurality of deposition heads;
wherein the first deposition head is configured to deposit the feedstock in a first area of the component; and
wherein the second deposition head is configured to deposit the feedstock in a second area of the component.

15. A method of additively manufacturing a component based on direct energy deposition (DED), the method comprising:
depositing feedstock from a material supply using a plurality of deposition heads, wherein the plurality of deposition heads are sized to deposit the feedstock from the material supply at different resolutions;
heating the feedstock using an energy source as the feedstock is deposited to form the component; and
reheating one or more portions of a surface of the component.

16. The method of claim 15, further comprising:
laser shock peening the surface of the component.

17. The method of claim 15, further comprising:
dispersing the feedstock to fill one or more areas of the surface between subsequent layers of the component, wherein the feedstock comprises a fine powder.

18. The method of claim 15, further comprising:
electroforming the surface of the component after the component is additively manufactured.

19. The method of claim 15, further comprising:
applying a binder to the feedstock and subsequently sintering the surface of the component, wherein the feedstock comprises a powder.

20. The method of claim 15, further comprising:
applying an ultrasonic wire-based repair process to one or more areas of the surface, wherein the feedstock comprises a wire.
